(19) United States
(12) Patent Application Publication
(10) Pub. No.: US 2008/0075964 A1
(43) Pub. Date: Mar. 27, 2008

(54) Paper coatings containing hydroxyethylcellulose rheology modifier and high levels of calcium carbonate pigment

(76) Inventors: Charles L. Burdick, Landenberg, PA (US); Sung G. Chu, Hockessin, DE (US); Teng-Shau Young, Wilmington, DE (US)

Correspondence Address: Hercules Incorporated;Hercules Plaza, 1313 North Market Street, Wilmington, DE, 19894-0001, US

(21) Appl. No.: 11/714,931

(22) Filed: Mar. 7, 2007

Related U.S. Application Data
(60) Provisional application No. 60/780,144, filed on Mar. 7, 2006.

(51) Int. Cl. B32B 27/20; C08K 3/26

(52) U.S. Cl. 428/500; 524/425

(57) ABSTRACT

A paper coating composition containing water, a binder, a high viscosity hydroxyethylcellulose polymer and a pigment, wherein the pigment comprises greater than about 80% by weight calcium carbonate pigment. Papers coated with the paper coating composition containing the high viscosity hydroxyethylcellulose polymer and calcium carbonate pigments exhibit improved water retention performance and good optical properties.

### RELATED APPLICATIONS

This application claims the benefit of U.S. Provisional Application Ser. No. 60/780,144 filed on Mar. 7, 2006, which is incorporated by reference in its entirety.

### FIELD OF THE INVENTION

The present invention relates to a composition of matter comprising a high solids, greater than about 64% by weight, paper coating containing greater than about 80% calcium carbonate by weight as its pigment component, standard binders, and at least one rheology modifier comprising a high viscosity hydroxyethylcellulose (HEC).

### BACKGROUND OF THE INVENTION

It is desired by the paper coating industry to employ rheology modifiers to achieve thickening, flow control, water retention and other properties in various paper coating formulations. A number of standard rheology modifiers are commercially employed in paper coatings including predominantly sodium carboxymethylcellulose (CMC) of various viscosity ranges, sodium alginate, low viscosity types of hydroxyethylcellulose (HEC), and alkali-soluble lattices. Starch has also been widely employed as both a binder and a water retention/viscosity control agent for many paper coatings, particularly for low solids paper coatings utilized for light weight coated paper production.

In cases where HEC has been employed commercially in paper coatings, its usage has involved low viscosity HEC types that display a solution viscosity at 2% concentration in water of less than 1000 cps. It has been found in that where mixtures of clay and calcium carbonate pigments are employed in paper coatings that low viscosity HEC types are much less effective and thus no appreciable commercial use of this latter HEC type has developed in the industry.

Coated paper manufacturers have traditionally employed either one or another rheology modifier, and in some case combinations of starch with one of the above standard rheology modifiers, as additives for paper coating compositions in order to attain desired rheological application properties, particularly water retention.

Aside from the rheology modifier, commercial paper coatings are typically composed of pigments, binders and additives. The pigment compositions of commercial paper coatings predominantly include mixtures of kaolin clay and calcium carbonate, with minor quantities of TiO₂, and plastic pigment employed only optionally. The standard binders of paper coatings include predominantly starch and styrene butadiene latex, along with minor quantities of protein and polyvinyl alcohol (PVOH) and specialty lattices such as poly(vinylacetate) latex. Various modifying additives in paper coating include components used in small proportions, less than about 2% by weight, as pH adjusters, biocides, lubricants, dyes and optical brightening agents.

With regard to paper coating pigment components in the case where calcium carbonate is utilized as one of the coating pigments, the predominant use has consisted of ground calcium carbonate (GCC) There has also been an interest of coated paper producers to employ lesser quantities of the specialty calcium carbonate pigment known as “precipitated calcium carbonate” (PCC) employed in combination with kaolin clay and other pigments.

The use in paper coatings of a very high or even 100% ratio by weight of calcium carbonate as the pigment, without kaolin clay present, is practiced in only a relatively small segment of commercial coating production. In these cases, the use of greater than about 70% calcium carbonate pigment by weight is motivated due to the beneficial property of enhanced brightness of calcium carbonate compared to kaolin clay/calcium carbonate pigment mixtures.

There is also a desire of the coated paper industry to utilize PCC since PCC can have still higher brightness and better glossing tendency in paper coatings than GCC. However, it has been observed by the industry that paper coatings utilizing greater than about 70% calcium carbonate by weight generally exhibits an undesirable rheological property of severe water loss from these coatings through absorption into the porous base sheet during application. This severe water loss is a phenomenon that may also be described as “poor water retention”. This poor water retention property is very problematic for the application of paper coatings containing 100% GCC as a pigment, and even more severe of a problem with the use of PCC as a pigment in paper coating compositions.

Poor water retention properties of paper coatings containing a 100% calcium carbonate pigment can readily be measured. These values are generally measured to be significantly worse compared to coating containing kaolin clay at a given % solids and viscosity level, (factors that affect the absolute water retention values, as measured). Due to this demonstrable problem with water retention, higher solids paper coating compositions, paper coating compositions with solids levels above about 64% by weight, with pigments containing of greater than about 70% by weight calcium carbonate, do not display acceptable coater runability, since immediately after a wet coating is applied to a porous base sheet, water loss from the wet coating into the porous base sheet causes a concentration of dense pigment solids under the coater blade producing unacceptable scratches and streaks on the resultant coated paper.

Because of this poor water retention property and associated runability problems and in order to allow acceptable application of the wet coating to the porous base sheet, the coated paper industry has been forced to utilize a relatively low solids coating formulation, i.e. solids levels below 64% by weight, when 100% calcium carbonate is employed as a pigment. However, the drawbacks of the use of lower solids coating formulations creates two additional significant problems: 1) the use of lower solids coating translates into higher drying energy costs of the coated paper industry, and 2) lower solids of coatings generally produces lower overall quality coated paper, since during the drying step when more water is employed in the coating recipe, then more binder migration and coating shrinkage occurs thereby affecting the finished coated paper quality negatively. The coated paper industry has tried to employ sodium carboxymethylcellulose (CMC) as a means to improve the water retention of paper coating containing 100% calcium carbonate pigment since CMC as a rheology modifier is well established in commercial practice as being one of the most effective water retention enhancing agents. However, the use of CMC has still not remediated the central water retention deficiency of paper coatings containing greater than about 70% calcium carbonate pigment, by weight.

For all of these reasons, the extent of commercial use of greater than about 70% calcium carbonate by weight coating by the coated paper industry has been severely limited; only a relatively low proportion of coated paper producers are employing greater than about 70% calcium carbonate by weight coatings. In cases were about greater than about 70% calcium carbonate by weight coating is used that usage is often simply for pre-coating applications where higher water levels and binder migration issues associated with greater than about 70% calcium carbonate in pigments use are not as prominent a factor in finished coated paper quality.

Thus there is a need for a rheology modifying agent that could be added to paper coating that have high levels of calcium carbonate pigment, greater than about 80% by weight, in order to improve water retention of these coating and thereby allow runability of coatings that contain higher solids, and wider use by the coating industry in application of high levels of calcium carbonate pigment in paper coatings. It is desired that a rheology modifier for paper coating in general be cellulosic in nature, due to beneficial adsorption properties of this species to the cellulose base sheet upon which paper coating are applied.

To address these issues, a cellulosic-based rheology modifier based on HEC that provides very effective water retention performance and good optical properties, specifically for greater than about 80% by weight calcium carbonate pigment systems, and blends with precipitated calcium carbonates has been developed.

### SUMMARY OF THE INVENTION

The paper coating composition of the present invention contains water, a binder, a high viscosity hydroxyethylcellulose polymer and a pigment, wherein the pigment comprises greater than about 80% by weight calcium carbonate pigment. The pigment may comprise higher levels of calcium carbonate such as greater than about 85% by weight calcium carbonate pigment, preferably greater than about 90% by weight calcium carbonate pigment, more preferably greater than about 95% by weight calcium carbonate pigment.

The calcium carbonate pigment may be in the form of a ground calcium carbonate or in the form of a precipitated calcium carbonate. The precipitated calcium carbonate may comprise up to about 100% by weight of the pigment

This invention has advantages in preparing coated paper with higher water retention than was previously attainable with CMC rheology modifiers that are the most common paper coating rheology modifier in commercial practice. The invention thus represents a cellulosic rheology modifier by use of which a performance properties can be attained that were not attainable by any previously known paper coating compositions containing greater than about 80% by weight calcium carbonate as a pigment.

This invention also is directed to a coated paper comprising a paper and on the paper an amount paper coating composition of the present invention from which the water has been reduced or removed.

### DETAILED DESCRIPTION OF THE INVENTION

It was the unexpected found that paper coatings containing a high proportion of calcium carbonate pigment, along with a HEC rheology modifier manifested significantly enhanced water retention and improved finished properties when applied to paper as compared to similar prior art coatings.

The present invention represents a preparation of paper coatings through incorporation of a hydroxyethylcellulose (HEC) employed in a paper coating containing up to about 80% calcium carbonate by weight as the pigment component, along with at least one binder. The standard binders of paper coatings include predominantly starch and styrene butadiene latex, along with minor quantities of protein and polyvinyl alcohol (PVOH) and specialty lattices such as poly(vinylacetate) latex.

The hydroxyethylcellulose (HEC) may be unmodified. Alternatively, the HEC may be hydrophobically modified hydroxyethylcellulose (HMHEC) where a long chain alkyl group is chemically bound to the cellulose backbone of the HEC.

The viscosity of the applicable HEC includes those products that produce a viscosity when dissolved in water at a concentration of 2% is greater than 2,500 centipoise (cps) at 100 rpm with a number 5 spindle using a Brookfield viscometer. For incorporation into paper coating, the HEC component may be added dry or as concentrated solution or as a fluidized polymer suspension. The calcium carbonate of the present invention may include ground calcium carbonate of standard types employed in the coatings industry. The calcium carbonate can also include mixtures with the calcium carbonate of up to 100% of precipitated calcium carbonate.

The binders of use in the coating compositions of the present invention include those binders which are commonly used in the paper coating arts. Common binders for use in paper coating compositions may be selected from the group consisting of protein, starch, styrene butadiene latex, styrene acrylate, polyvinyl acetate, and polyvinyl alcohol.

In a systematic test series comparing standard paper coating rheology modifiers against new water soluble polymers, it was unexpectedly found that HEC with viscosities above 2,500 cps provided unexpected benefits in water retention compared to standard previously known rheology modifiers. The present invention finding, that the combined use of high viscosity HEC, viscosities greater than about 4,500 cps, as measured in 2% solution in water, at 100 rpm with a number 5 spindle using a Brookfield viscometer, with greater than about 80% calcium carbonate by weight pigment paper coatings exhibits exceptional water retention and coated paper results. Preferably, high viscosity HEC of use in the coating compositions of the present invention, has a viscosity in the range of from about 4,500 cps to about 6,500 cps as measured in 2% solution in water, at 100 rpm with a number 5 spindle using a Brookfield viscometer. More preferably the high viscosity HEC of use in the coating compositions of the present invention has a viscosity of about 5,000 cps. as measured in 2% solution in water, at 100 rpm with a number 5 spindle using a Brookfield viscometer. Previously only medium or low viscosity HEC, viscosities of less than about 2,500 cps, were used in coatings and these products were not effective for paper coating containing mixtures of kaolin clay and calcium carbonate.

It has been found that the preparations of liquid fluidized polymer suspensions of HEC are a preferred form of HEC for use in the present invention. U.S. Pat. No. 5,028,263, incorporated herein in its entirety by reference, discloses water-soluble polymer suspensions which are useful in producing the paper coatings of the present invention as an alternative means of using HEC in the production of paper coatings instead of using HEC in dry powder form. Liquid fluidized HEC suspensions or use in the present invention may contain 15% or more of the particulate HEC. Preferably, the concentration of HEC will be in the range of 20 to 50%. The liquid fluidized polymer suspensions of HEC comprising 15% or more, by total weight of the suspension, of HEC dispersed in an aqueous solution of an ammonium salt having a multivalent anion, wherein the weight ratio of the ammonium salt to the water is at least 0.15. Any ammonium salt having a multivalent anion and which may be dissolved in water to a sufficiently high concentration that it will render the HEC insoluble with minimal swelling, can be used. Among the ammonium salts of use in producing the liquid fluidized polymer suspensions of HEC are diammonium phosphate, diammonium sulfate (also known as ammonium sulfate), ammonium polyphosphate, and mixtures thereof.

Alternatively, the HEC may be used dry powdered HEC rather than as a liquid fluidized polymer suspension in producing the paper coatings of the present invention.

The invention is further demonstrated by the following examples. The examples are presented to illustrate the invention, parts and percentages being by weight, unless otherwise indicated.

### EXAMPLE 1

Five paper coating formulations were prepared according to recipes shown in Table 1. Various fluidized polymer suspensions of various HEC viscosity types were prepared separately as shown in Table 2. Two comparative HEC and one high molecular weight HEC are listed therein. Other control rheology modifiers employed are detailed in Table 3.

TABLE 1
Paper Coating Formulations

| | Coating Recipe: | | | | |
|---|---|---|---|---|---|
| | Recipe 1 | Recipe 2 | Recipe 3 | Recipe 4 | Recipe 5 |
| Hydracarb | 60 parts | 60 parts | 60 parts | 60 parts | 100 parts |
| 60*GCC | | | | | |
| Hydracarb | 40 parts | 40 parts | 40 parts | — | — |
| 90*GCC | | | | | |
| Opacarb A-40 | — | — | — | 40 parts | — |
| precipitated | | | | | |
| calcium carbonate | | | | | |
| Dow 620 | 12 parts | 10 parts | 12 parts | 12 parts | 12 parts |
| SB latex | | | | | |
| Penford 290 | 0 parts | 3 parts | 0 parts | 0 parts | 3 parts |
| ethylated starch | | | | | |
| Calcium stearate | 1 parts | 1 parts | 1 parts | 1 parts | 1 parts |
| Dispex N-40 | 0.25 parts | 0.25 parts | 0 parts | 0 parts | 0.1 parts |
| (dispersing agent) | | | | | |
| Solids (%) | 66, 68, 70 | 66, 68, 70 | 68 | 66 | 65 |
| Viscosity | 1000, 1500, | 1000, 1500, | 1000-1500 | 1000-1500 | 1000-1500 at |
| (cps): | 2000 at ambient | 2000 at 35° C. | at ambient | at ambient | ambient |
| | temperature | | temperature | temperature | temperature |

* Hydracarb ® ground calcium carbonate available from OMYA Inc.
** Opacarb ® precipitated calcium carbonate available from Specialty Minerals Inc.

The rheology modifiers of Tables 2-3 are employed to thicken the various coating recipes of Table 1 to constant Brookfield viscosity values then the static water retention is measured by a standard process employing a Kaltec GWR water retention laboratory apparatus. The results for water retention values measured with various paper coating compositions is shown in Tables 4-6.

TABLE 2
Composition of Hydroxyethylcellulose Fluidized
Polymer Suspension Rheology Modifiers

| | HEC FPS name: | | |
|---|---|---|---|
| | Natrosol ® | Natrosol ® | Natrosol ® |
| | 250GR HEC | 250KR HEC | 250MR HEC |
| | FPS (Compar- | FPS (Compar- | FPS |
| FPS Ingredients | ative ex.) | ative ex.) | (Example) |
| Water | 57.8 wt % | 57.8 wt % | 57.8 wt % |
| Xanthan gum | 0.1 wt % | 0.1 wt % | 0.1 wt % |
| CMC-7L1T | 1.0 wt % | 1.0 wt % | 1.0 wt % |
| carboxymethylcellulose, | | | |
| available from Hercules | | | |
| Incorporated | | | |
| Diammonium phosphate | 16.0 wt % | 16.0 wt % | 16.0 wt % |
| Hydroxyethylcellulose | 25 wt % | 25 wt % | 25 wt % |
| Type: | Natrosol ® | Natrosol ® | Natrosol ® |
| | 250GR HEC | 250KR HEC | 250MR HEC |
| Preservative | 0.1 wt % | 0.1 wt % | 0.1 wt % |
| 2% HEC solution | <150-400 cps | 1,500-2500 | 4,500-6,500 |
| viscosity in water | | cps | cps |
| measured with #5 | | | |
| spindle at 100 rpm | | | |

TABLE 3
List of Rheology Modifiers

| Product name | Description |
|---|---|
| Natrosol ® 250GR HEC FPS | Low viscosity HEC (<150-400 cps) |
| Natrosol ® 250KR HEC FPS | Medium viscosity HEC (1,500-2,500 cps) |
| Natrosol ® 250MR HEC FPS | High viscosity HEC (about 4,500-6,500 |
| | cps) |
| CMC-7L1T, | Low viscosity CMC |
| carboxymethylcellulose | (available from Hercules Incorporated) |
| Finnfix ® 30G CMC | Medium viscosity CMC |
| | (available from Noviant OY) |
| Alcogum ® 289 rheology | Alkali soluble latex, medium viscosity |
| modifier | in water (available from Alco products) |
| Alcogum ® SL 78 rheology | Alkali soluble latex, high viscosity in |
| modifier | water (available from Alco products) |

TABLE 4
Water Retention of Paper Coating (Recipe 1) Containing various Rheology Modifiers

| | | | Rheology | | |
|---|---|---|---|---|---|
| | Coating | Coating | modifier | | Average water |
| Rheology Modifier | (% Solid) | Viscosity (cps) | Dosage (parts) | Water Loss**(g) | loss (g) |
| Natrosol ® 250GR HEC | 70.4 | 2010 | 0.45 | 105.1 | 101 |
| FPS | | | | | |
| (Comparative Ex.) | | | | | |
| Natrosol ® 250GR HEC | 70.54 | 2010 | 0.4217 | 96.875 | |
| FPS | | | | | |
| (Comparative Ex.) | | | | | |
| Natrosol ® 250MR HEC | 70.5 | 2040 | 0.33 | 89 | 94. |
| FPS | | | | | |
| (Example 1) | | | | | |
| Natrosol ® 250MR HEC | 70.18 | 2040 | 0.331 | 101.9 | |
| FPS | | | | | |
| (Example 1) | | | | | |
| Natrosol ® 250MR HEC | 70.21 | 2020 | 0.300 | 91.75 | |
| FPS | | | | | |
| (Example 1) | | | | | |
| Natrosol ® 250KR HEC | 70.5 | 2050 | 0.398 | 95.6 | 93 |
| FPS | | | | | |
| (Comparative Ex.) | | | | | |
| Natroso ®l 250KR HEC | 70.51 | 2000 | 0.3615 | 89.75 | |
| FPS | | | | | |
| (Comparative Ex.) | | | | | |
| CMC7L1C | 70.6 | 2030 | 0.75 | 152 | 154 |
| CMC7L1C | 70.58 | 2020 | 0.75 | 156.3 | |
| Finnfix ® 30 CMC | 69.97 | 2060 | 0.70 | 138.13 | 138 |
| Alcogum ® 289 | 70.56 | 2050 | 0.244 | 90.12 | 90. |
| rheology modifier | | | | | |
| Alcogum ® SL78 | 70.7 | 2020 | 0.25 | 83 | 83 |
| rheology modifier | | | | | |

*VT Brookfield viscometer @ 100 rpm using a #5 spindle
**Static water retention measurement by Kaltec GWR, grams water loss @ 0.6 bar pressure/min per millipore filter
Lower numbers indicate improved water retention

TABLE 5
Water Retention Values of Paper Coating Formulations
(Recipe 2) with Various Rheology Modifiers

| | | Coating | Rheology | |
|---|---|---|---|---|
| | Coating | Viscosity*, | modifier | Coating Water** |
| Rheology Modifiers | (% Solid) | (cps) | Dosage (parts) | loss values (g) |
| Natrosol ® 250GR HEC FPS | 69.92 | 2060 | 0.3314 | 57 |
| (Comparative Ex) | | | | |
| Natrosol ® 250MR HEC FPS | 70.11 | 2050 | 0.2975 | 57 |
| (Example 1) | | | | |
| Natrosol ® 250KR HEC FPS | 69.81 | 2050 | 0.3133 | 60 |
| (Comparative Ex.) | | | | |
| CMC7L1C | 70.35 | 2060 | 0.5 | 91 |
| Finn Fix 30 CMC | 70.25 | 2060 | 0.4 | 84 |
| Natrosol ® 250MR HEC FPS | 69.87 | 2020 | 0.284 | 59 |
| (Example 1) | | | | |
| CMC7L1C | 70.05 | 2060 | 0.542 | 88 |
| Natrosol ® 250MR HEC FPS | 67.91 | 1490 | 0.284 | 64 |
| (Example 1) | | | | |
| CMC7L1C | 68.05 | 1500 | 0.652 | 87 |
| Natrosol ® 250MR HEC FPS | 66.13 | 996 | 0.284 | 71 |
| (Example 1) | | | | |
| CMC7L1C | 66.08 | 1000 | 0.625 | 107 |
| Alcogum ® 289 rheology modifier | 70.38 | 2070 | 0.2049 | 56 |
| Alcogum ® SL78 rheology modifier | 69.74 | 2010 | 0.249 | 54 |
| Alcogum ® SL78 rheology modifier | 67.98 | 1470 | 0.249 | 62 |
| Alcogum ® SL78 rheology modifier | 65.96 | 1000 | 0.249 | 65 |

*VT Brookfield viscometer @ 100 rpm using a #5 spindle
**Static water retention measurement by Kaltec GWR, grams water loss @ 0.6 bar pressure/min per millipore filter, lower numbers indicate improved water retention

TABLE 6
Water Retention Values of Paper Coating of Recipe 5

| | Rheology Modififier | Coating | Water retention |
|---|---|---|---|
| Rheology modifier | Dosage | Viscosity | value (g) |
| Natrosol ® 250GR | 0.25 parts | 1300 cps | 155 |
| FPS HEC | | | |
| (Comparative Ex.) | | | |
| Natrosol ® 250MR | 0.14 parts | 1290 cps | 86 |
| FPS HEC | | | |
| (Example 1) | | | |

* VT Brookfield viscometer @ 100 rpm using a #5 spindle
** Static water retention measurement by Kaltec GWR, grams water loss @ 0.6 bar pressure/min per millipore filter, lower numbers indicate improved water retention

It was observed that certain viscosity types of HEC suspensions, Natrosol® 250MR FPS HEC, available from Hercules Incorporated, unexpectedly produced improved water retention values in coating recipes 1-5 of Table 1. (lower water loss number are translated as improved water retention values). In these tests, the control rheology modifier CMC, known in the coating industry as a rheology modifier with strong water retention, gave much poorer performance than coating compositions of the present invention.

The alkali-soluble polymer rheology modifiers tested in Tables 4-5 (Alkali soluble latex, Alcogum® rheology modifiers available from Alco products) were found to also produce good water retention values. However, this latter type of rheology modifier is known to have limited performance in industrial practice due to less effective overall coating performance compared to cellulosic polymers.

### EXAMPLE 2

Paper coatings were prepared according to recipes 3 and 4 from Table 1. These coating were then applied to a standard free sheet base paper by means of a cylindrical laboratory coater at a velocity of 1300 m/min to a targeted coat weight of 13 gm/m2 and dried by standard practice infrared dryer at high speed. The coated paper samples were calendered with 2 nips of a laboratory calendar (Beloit Wheeler, Model 703 lab calendar) at a standard temperature of 150° F. (65.6° C.) and 1000 psi pressure, and then the coated paper samples were measured for standard optical properties. It was found that the composition of the present invention, 100% calcium carbonate coatings employing the rheology modifier Natrosol® 250MR FPS HEC produced significantly enhanced water retention and gloss compared to the control paper coating that employed CMC as a rheology modifier. These results are shown in Tables 7 and 8.

TABLE 7
Optical properties of coated papers with Paper Coating Recipe 3 formulation,
Applied to paper by Cylindrical Coater at 13 gm/m2 coating weight

| | | | Rheology | | Hercules | Coating | | |
|---|---|---|---|---|---|---|---|---|
| | | | modifier | | High Sheer | Water ret. | Optical Properties | |
| | Recipe #3 | Rheology | Dosage, | Brookfield | Visco. | GWR | (calendared coated paper) | |
| Test | Pigments | modifier | (parts) | viscosity | (HHSV), cps | values | brightness | gloss |
| 1 | 100% GCC | CMC-7L | 0.87 | 1560 cps | 48.5 | 115 | 83.9 | 35.1 |
| 2 | 100% GCC | Natrosol ® | 0.34 | 1380 cps | 53.0 | 104 | 84.3 | 40.0 |
| | | 250MR FPS | | | | | | |
| | | HEC | | | | | | |
| | | (Example 2) | | | | | | |

TABLE 8
Optical properties of coated papers with Paper Coating Recipe 4 Formulations,
Applied to paper by Cylindrical Coater at 13 gm/m2 coating weight

| | | | Rheology | | Hercules | Coating | | |
|---|---|---|---|---|---|---|---|---|
| | | | modifier | | High Sheer | Water ret. | Optical Properties | |
| | Recipe #4 | Rheology | Dosage, | Brookfield | Viscosity | GWR | (calendared coated paper) | |
| Test | Pigments | modifier | (parts) | viscosity | (HHSV), cps | values | brightness | gloss |
| 3 | 60/40 GCC/PCC | Natrosol ® | 0.31 | 1400 cps | 57.2 | 112 | 85.5 | 42.3 |
| | | 250MR FPS | | | | | | |
| | | HEC | | | | | | |
| | | (Example 2) | | | | | | |
| 4 | 60/40 GCC/PCC | CMC-7L | 0.75 | 1350 cps | 46.6 | 130 | 85.2 | 37.9 |

### EXAMPLE 3

Various paper coating compositions were made using CMC as a rheological modifier and comparing these coating compositions with coating compositions containing the high viscosity HEC rheology modifier of use in paper coating compositions of the present invention when an amount of clay is used along with calcium carbonate in the pigments for use in the coating composition.

As can be seen in Table 9, Example 3 (Natrosol® 250MR FPS HEC, available from Hercules Incorporated) generates higher thickening efficiency than CMC7LC1 at all ratios of carbonates and #2 clay. Example 3 has generated higher water retention than CMC when the paper coating formulations contain more than 60% carbonates. However it was observed that when paper coating formulations contain more than 40% #2 clay, CMC 7LC1 generated better water retention than Example 3.

TABLE 9
Thickening Efficiency and Water Retention of Example 3 for Various Paper Coating Formulations

| | | | | Brookfield Viscosity | | | |
|---|---|---|---|---|---|---|---|
| Pigments | | % Solid | | @ 100 rpm with #5 spindle | | Thickening efficiency | |
| % HC60 | % #2 clay | CMC 7LC1 | Example 3 | CMC 7LC1 | Example 3 | CMC 7LC1 | Example 3 |
| 50 | 50 | 67.5 | 66.8 | 1480 | 1530 | 0.54 | 0.41 |
| 60 | 40 | 67.2 | 66.4 | 1500 | 1540 | 0.68 | 0.385 |
| 70 | 30 | 67.7 | 66.5 | 1440 | 1550 | 0.76 | 0.44 |
| 80 | 20 | 67.3 | 66.3 | 1460 | 1520 | 0.88 | 0.42 |
| 90 | 10 | 67.3 | 65.1 | 1550 | 1630 | 0.83 | 0.42 |
| 100* | 0 | 66.1 | 64.6 | 1450 | 1630 | 0.498 | 0.25 |

| | | | | Water Retention | | | |
|---|---|---|---|---|---|---|---|
| Pigments | | % Solid | | (loss in g). | | H.S. Viscosity | |
| % HC60 | % #2 clay | CMC 7LC1 | Example 3 | CMC 7LC1 | Example 3 | CMC 7LC1 | Example 3 |
| 50 | 50 | 67.5 | 66.8 | 81.9 | 107 | 80.1/67.9 | 79.6/48.9 |
| 60 | 40 | 67.2 | 66.4 | 109.1 | 101.4 | 56.7/51.8 | 48.8/44.5 |
| 70 | 30 | 67.7 | 66.5 | 118.4 | 89.5 | 60.6/54.7 | 62.6/46.2 |
| 80 | 20 | 67.3 | 66.3 | 128 | 91.5 | 53.2/49.2 | 60.8/45.5 |
| 90 | 10 | 67.3 | 65.1 | 137.9 | 93.1 | 48.5/43.9 | 54.8/46.7 |
| 100* | 0 | 66.1 | 64.6 | 183.5 | 100.3 | 29.7/25.9 | 57.1/49.3 |

*HC60/HC90(60/40)

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended

What is claimed:

1. A paper coating composition comprising water, a binder, a high viscosity hydroxyethylcellulose polymer and a pigment, wherein the pigment comprises greater than about 80% by weight calcium carbonate pigment.

2. The paper coating composition of claim 1, wherein the pigment comprises greater than about 85% by weight calcium carbonate pigment.

3. The paper coating composition of claim 2, wherein the pigment comprises greater than about 90% by weight calcium carbonate pigment.

4. The paper coating composition of claim 3, wherein the pigment comprises greater than about 95% by weight calcium carbonate pigment.

5. The paper coating composition of claim 1, wherein the calcium carbonate pigment further comprises a ground calcium carbonate.

6. The paper coating composition of claim 1, wherein the calcium carbonate pigment further comprises a precipitated calcium carbonate.

7. The paper coating composition of claim 6, wherein the precipitated calcium carbonate comprises up to about 100% by weight of the pigment.

8. The paper coating composition of claim 1, wherein the high viscosity hydroxyethylcellulose polymer is in a dry powder form.

9. The paper coating composition of claim 1, wherein the high viscosity hydroxyethylcellulose polymer is in a liquid suspension form.

10. The paper coating composition of claim 1, wherein the high viscosity hydroxyethylcellulose polymer is hydrophobically modified hydroxyethylcellulose (HMHEC).

11. The paper coating composition of claim 1, wherein the a high viscosity hydroxyethylcellulose polymer has a viscosity of greater than 2,500 cps as measured in a 2% aqueous solution by a Brookfield viscometer with a number 5 spindle at 100 rpm.

12. The paper coating composition of claim 11, wherein the a high viscosity hydroxyethylcellulose polymer has a viscosity in the range of from about 4,500 cps to about 6,500 cps as measured in a 2% aqueous solution by a Brookfield viscometer with a number 5 spindle at 100 rpm.

13. The paper coating composition of claim 12, wherein the a high viscosity hydroxyethylcellulose polymer has a viscosity of about 5,000 cps as measured in a 2% aqueous solution by a Brookfield viscometer with a number 5 spindle at 100 rpm.

14. The paper coating composition of claim 1, wherein the binder is selected from the group consisting of protein, starch, styrene butadiene latex, styrene acrylate, polyvinyl acetate, and polyvinyl alcohol.

15. The paper coating composition of claim 1 wherein the pigment further comprises a kaolin clay.

16. A coated paper comprising a paper and an amount of paper coating on the paper wherein paper coating is further comprised of a paper coating composition comprising a binder, a high viscosity hydroxyethylcellulose polymer and a pigment, wherein the pigment comprises greater than about 80% by weight calcium carbonate pigment.
